(19) United States
(12) Patent Application Publication
(10) Pub. No.: US 2012/0199438 A1
(43) Pub. Date: Aug. 9, 2012

(54) COIN PROCESSING APPARATUS AND METHOD

(75) Inventor: Yuki Taniike, Shizuoka-ken (JP)

(73) Assignee: TOSHIBA TEC KABUSHIKI KAISHA, Tokyo (JP)

(21) Appl. No.: 13/356,761

(22) Filed: Jan. 24, 2012

(30) Foreign Application Priority Data
Feb. 7, 2011 (JP) 2011-024124

(51) Int. Cl. G07F 1/00

(52) U.S. Cl. 194/344

(57) ABSTRACT

A coin processing apparatus detects the existence of the residual coins on the dispensing tray if the time during which an optical residual coin detection unit detects no dispensed coins on the dispensing tray (S3: yes) is beyond an allowable no-coin time (S4: yes).

### CROSS-REFERENCE TO RELATED APPLICATION

This application is based upon and claims the benefit of priority from Japanese Patent Application No. 2011-024124, filed Feb. 7, 2011, the entire contents of which are incorporated herein by reference.

### FIELD

Embodiments described herein relate generally to a coin processing apparatus and method.

### BACKGROUND

At present, a bill processing apparatus connected with an upper device such as a Point Of Sales (POS) system and a coin processing apparatus for receiving coins and dispensing change to a dispensing tray are used in a checkout counter installed in a supermarket or convenience store. In the coin processing apparatus, the residual coins that are left on a dispensing tray during a dispensing from the dispensing tray (hereinafter referred to as “residual coins”) are detected by a transmissive optical sensor. Moreover, the processing is paused if there are residual coins, and then the residual coins are reported to be removed.

### BRIEF DESCRIPTION OF THE DRAWINGS

FIG. 1 is a perspective view showing the appearance of a coin processing apparatus according to an embedment;

FIG. 2 is a perspective view showing the main components of the coin processing apparatus shown in FIG. 1;

FIG. 3 is a rough planar graph of a dispensing tray;

FIG. 4 is a block diagram showing the hardware components of the coin processing apparatus according to the embedment;

FIG. 5 is a flow chart showing the action of the coin processing apparatus according to the embedment;

FIG. 6 is a diagram illustrating an exemplary display content of a display;

FIG. 7 is a diagram illustrating an exemplary display content of the display.

### DETAILED DESCRIPTION

According to one embodiment, a coin processing apparatus is provided, which comprises: a dispensing tray for holding the dispensed coins; a detection sensor for detecting whether or not there are residual coins on the dispensing tray; and a residual coin detector, by which the existence of the residual coins on the dispensing tray is detected if the time during which the detection sensor detects no dispensed coins on the dispensing tray is beyond an allowable no-coin time.

According to another embodiment, a coin processing method, comprising: detecting whether or not there are dispensed coins on a dispensing tray; and detecting residual coins on the dispensing tray at the time that the elapsed time from the time when coins are dispensed until the time of no coins on the dispensing tray have not passed the allowable time.

The coin processing apparatus and method provided herein are described in detail below with reference to accompanying drawings.

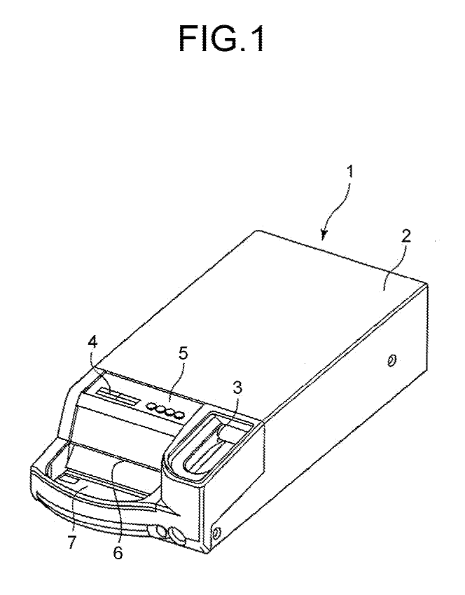

FIG. 1 is a perspective view showing the appearance of a coin processing apparatus according to an embedment of the present invention. As shown in FIG. 1, a coin processing apparatus 1 is provided with a housing 2, which has a smaller width (with respect to the length) and a fixed height. A coin slot 3 is arranged on the right-upper portion of the housing 2 for the user to insert a plurality of coins at a time. An operation panel 5 provided with a display 4 and a plurality of operating buttons is arranged on the residual side of the coin slot 3. It should be appreciated that the mentioned above is merely an example of the layout of the housing 2 but not a limitation to the layout of the housing 2.

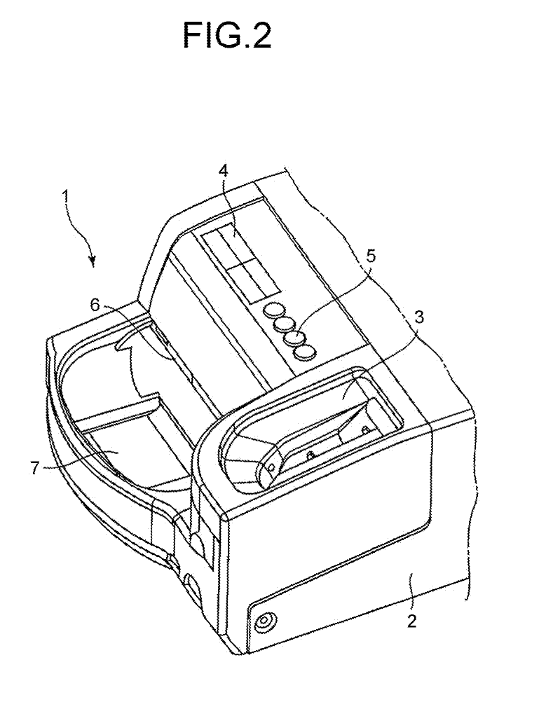

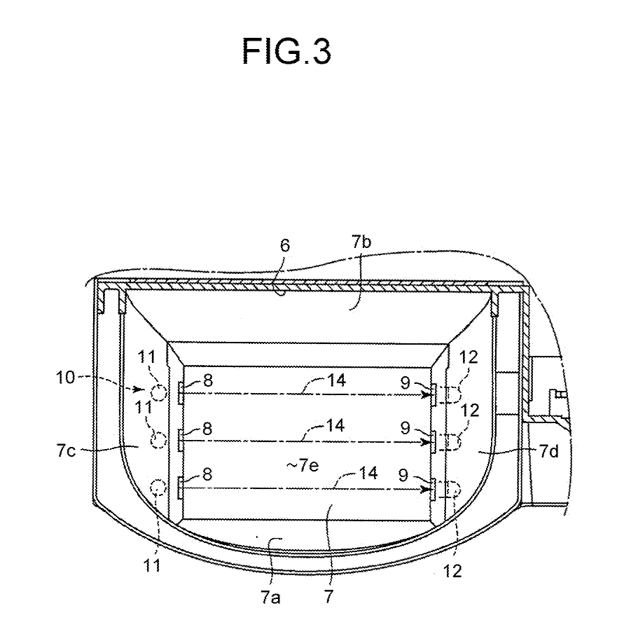

FIG. 2 is a perspective view showing the main components of the coin processing apparatus 1 shown in FIG. 1. As shown in FIG. 2, a dispensing port 6 arranged at a position close to the display 4 provided at the front of the housing 2. A dispensing tray 7 provided with an optical residual coin detection unit 10 (referring to FIG. 3) is arranged below the outlet 6. Besides, a returning outlet (not shown) for returning an inserted coin is arranged at a position nearby the coin slot 3.

A classified denomination storing unit (not shown) is arranged inside the housing 2; the coins inserted into the coin slot 3 are temporarily stored in the housing 2 and then transferred to the classified denomination storing unit after adding up to a certain amount. At this time, the amount of the inserted coins is displayed on the display 4.

A desired amount of inserted coins and an action state of or an operation instruction for the coin processing apparatus 1 can also be displayed on the display 4. Moreover, in the coin processing apparatus 1, it can also be configured that in addition to the coins that are discharged (dispensed) from the dispensing port 6 as changes, coins that cannot be identified as a genuine one and are therefore returned and coins that are recovered from the coin processing apparatus 1 are also dispensed to the dispensing tray 7.

The shape and the structure of the dispensing tray 7 for holding the coins discharged from the dispensing port 6 of the coin processing apparatus 1 and the optical residual coin detection unit 10 arranged at the dispensing tray 7 are described below.

FIG. 3 is a rough planar graph of the dispensing tray 7. As shown in FIG. 3, the dispensing tray 7 comprises a front inclined surface 7a that is located at a coin takeout side facing an operator or dispensing-receiving users, such as customers, in an automatic cash register, a back inclined surface 7b connected with the dispensing port 6, a left and right inclined surfaces 7c and 7d serving as a residual and right sides, and a horizontal bottom surface 7e connecting the lower ends of the aforementioned inclined surfaces.

The front inclined surface 7a, the back inclined surface 7b, the left inclined surface 7c and the right inclined surface 7d are formed as an inclined plane which gradually narrow from the upper end to the lower end, so that the dispensing tray 7 has a big upper end serving as an opening and a narrow lower end connected with the horizontal bottom surface 7e.

Actually, the coins dispensed from the dispensing port 6 slide along a sliding chute on the back inclined surface 7b of the dispensing tray 7 and are held on the horizontal bottom surface 7e. Then, the front inclined surface 7a, the left inclined surface 7c and the right inclined surface 7d of the dispensing tray form an appropriate depth to prevent the coins discharged from the dispensing port 6 from bouncing to the outside.

The width of the horizontal bottom surface 7e is configured based on the size of the fingers (except thumb) of an adult male so that the user is easy to insert fingers into the dispensing tray 7 and as the optimally area that these dispensed coins are not in a mess but in amass and in piles in a dispersed state. The inclined angle and the inclined length of the front inclined surface 7a are optimally set to facilitate the easy takeout of coins from the horizontal bottom surface 7e.

Thus, the user who receives the dispensed coins can easily observe and confirm the coins on the horizontal bottom surface 7e of the dispensing tray 7 and insert fingers to the dispensing tray 7 to gather the coins. Besides, the user can easily take out the gathered coins from the horizontal bottom surface 7e through the front inclined surface 7a. That is, the dispensing tray 7 is designed to be in a human engineering optimal shape.

Besides, a plurality of light-emitting side slots 8, a plurality of light-receiving side slots 9 and an optical residual coin detection unit 10 are arranged on the dispensing tray 7 to detect residual coins on the dispensing tray 7.

Specifically, at the lowest part of the left inclined surface 7c of the dispensing tray 7 connected with the horizontal bottom surface 7e, a plurality of (3) light-emitting side slots 8 are vertically arranged at regular distance, and at the lowest part of the right inclined surface 7d connected with the horizontal bottom surface 7e, a plurality of (3) light-receiving side slots 9 are arranged opposite the light-emitting side slots 8.

It is designed that the lowest part of each of the light-emitting side slots 8 and the light-receiving side slots 9 is on the horizontal bottom surface 7e of the dispensing tray 7, and each of the light-emitting side slots 8 and the light-receiving side slots 9 has parallel upper and lower ends and parallel left and right sides, thereby forming a regular opening. Moreover, each of the light-emitting side slots 8 and the light-receiving side slots 9 has a width that is a certain value greater than the length thereof.

The shape of the light-emitting side slots 8 and the light-receiving side slots 9 is not limited to the mentioned above, however, the setting of the light-emitting side slots 8 and the light-receiving side slots 9 at the same positions of the left and right inclined surfaces 7c and 7d in the same shape can facilitate the design and the production of the slots.

Light-emitting sensors 11 (light-emitting components) are arranged in the outer space intervals of the left inclined surface 7c of the dispensing tray 7, with the light-emitting side thereof facing the light-emitting side slot 8. Light-receiving sensors (light-receiving components) are arranged in the outer space intervals of the right inclined surface 7d of the dispensing tray 7, with the light-receiving side thereof facing the light-receiving side slot 9.

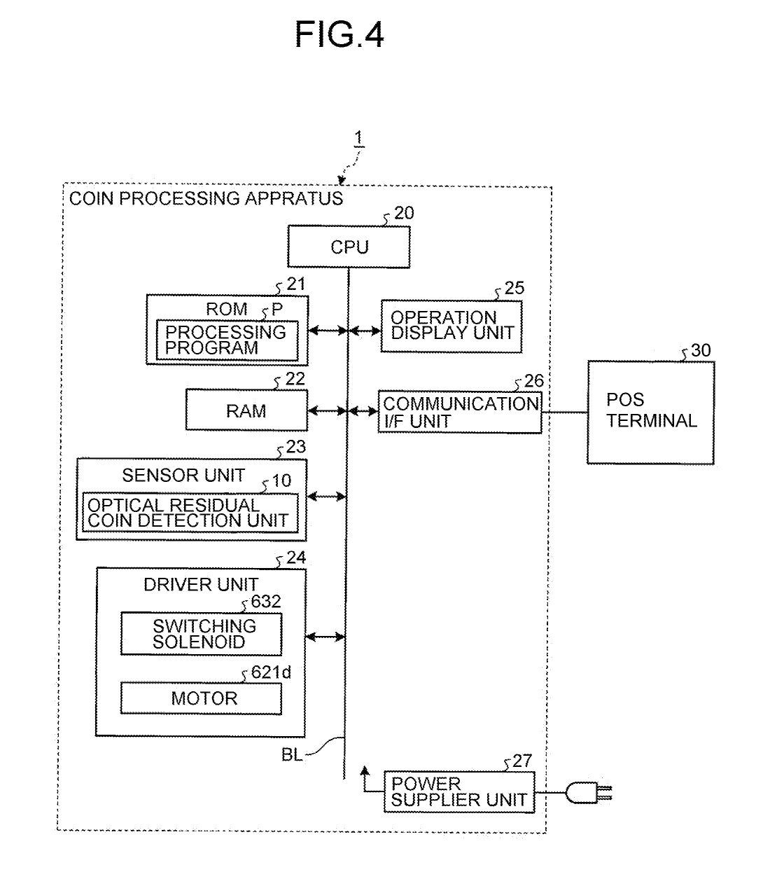

Each light-emitting sensor 11 and each light-receiving sensor 12 are supported on sensor mounting plates (not shown) and electrically connected with a CPU 20 (referring to FIG. 4) via a bus line (BL) (referring to FIG. 4). The three groups of light-emitting sensors 11 and light-receiving sensors 12 form the optical residual coin detection unit 10.

The light shaft 14 of light emitted from the light-emitting sensor 11 extends along the horizontal bottom surface 7e through the light-emitting side slots 8. Moreover, the optical shaft 14 traverses the horizontal bottom surface 7e to reach the light-receiving side slot 9 opposite the light-emitting side slot 8, and then reaches the light-receiving sensor 12 via the light-receiving side slot 9 to be received. Thus, by means of the light output from the light-receiving sensors 12 in the optical residual coin detection unit 10, presence/absence of coins on the dispensing tray 7 can be detected by detecting whether or not the optical shaft 14 is blocked by the coins on the horizontal bottom surface 7e In addition, the detection of residual coins with light described here in the present embodiment is merely an example but not a limitation to the present invention. For instance, residual coins can also be magnetically detected.

The hardware components of the coin processing apparatus 1 are described below. FIG. 4 is a block diagram showing the hardware components of the coin processing apparatus according to the present embedment.

As shown in FIG. 4, the coin processing apparatus comprises, in the housing 2, a CPU (Central Processing Unit) 20, an ROM (Read Only Memory) 21 connected with the CPU 20 via a bus-line BL, an RAM (Random Access Memory) 22, a sensor unit 23, a driver unit 24, an operation display unit 25, a communication I/F unit 26 and a power supplier unit 27.

The CPU 20 controls the whole coin processing apparatus 1, that is, controls the various processing on each operational or structural component. The ROM is used for storing various files including a processing program P for executing various processing in the coin processing apparatus 1. The RAM 22 is used for temporality storing input data or display data as well as the processing program P read from the ROM 21 when the coin processing apparatus 1 is started and the like.

In addition to the optical residual coin detection unit 10, the sensor 23 further comprises other sensors such as a receiving sensor (not shown), a counting sensor (not shown), and a dispensing sensor (not shown). As being similar to the optical residual coin detection unit 10, the receiving sensor, the counting sensor and the dispensing sensor optically detect the pass of a coin and output a detection signal to the CPU 20. In the CPU 20, the receiving of a coin from the coin slot 3, the number of the coins receiving and the dispensing of a coin from the dispensing port 6 are all detected according to detection signals. In addition, in this embodiment, it is designed that dispensing sensors are respectively set by classified denomination, so as to check the number of the dispensed coins by classified denomination.

Under the control of the CPU 20, the driver unit 24 drives a switching solenoid 632 that switches the dispensing of coins, or drives the motor 621d of a guide belt (not shown) that guides the coins receiving from the coin slot 3. Under the control of the CPU 20, the operation display unit 25 displays various kinds of information on a display 4 or accepts the operation input from the operation panel 5. The communication I/F unit 26 is a communication interface for transmitting various data between the coin processing apparatus 1 and POS terminal 30 that is connected with the coin processing apparatus 1 via a communication cable (not shown) and serves as an upper device. The power supplier unit 27 supplies power for each component of the coin processing apparatus 1. Specifically, a commercial power supplier is connected with a loaded unit via an inserter such as plug to power the loaded unit.

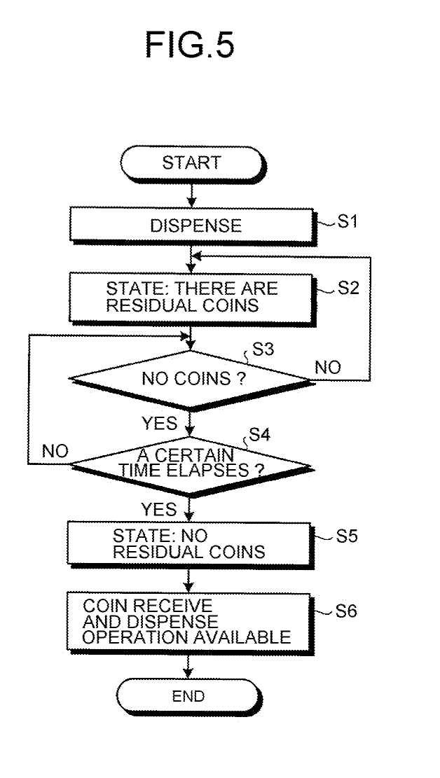

The series of processing according to the detection of the residual coins dispensed from the dispensing tray 7 under the control of the CPU 20 is described in detail below. FIG. 5 is a flow chart of an exemplary operation of the coin processing apparatus 1 according to the present embedment of the present invention. More specifically, FIG. 5 exemplarily shows the series of processing according to the detection of the residual coins after coins are dispensed from the dispensing tray 7.

As shown in FIG. 5, coins are dispensed from the dispensing port 6 (S1) when the processing is started, and the CPU 20 sets a state flag indicating presence/absence of residual coins temporarily stored in the RAM 22 as ‘Yes’ (S2)

In addition, the existence of the residual coins left during a dispensing from the dispensing port 6 may be set (S2) when the dispensing sensor detects the dispensing of coins or the optical residual coin detection unit 10 detects the existence of coins on the dispensing tray 7. However, as some users are likely to catch the coins dispensed from the dispensing port 6 directly with hands, it would be better to set the existence of residual coins when the dispensing sensor detects the dispensing of coins. In the case where the existence of residual coins is set when the dispensing sensor detects the dispensing of coins, even if the user fails to catch, directly with hands, coins dispensed from the dispensing port 6, the dropped coins can also be detected as residual coins in the processing (S3-S5) that will be described later.

Then, the CPU 20 judges whether or not there are coins on the dispensing tray 7, based on the output from the optical residual coin detection unit 10 (S3). If the output from the optical residual coin detection unit 10 shows light is blocked by the coins on the dispensing tray 7, the CPU 20 determines there are coins on the dispensing tray 7 (S3: No) and then returns to execute the processing of S2. If the output from the optical residual coin detection unit 10 shows light is not blocked by the coins on the dispensing tray 7, the CPU 20 determines there are no coins on the dispensing tray 7 (S3: Yes), and then judges whether or not a preset time elapses after the moment at which the absence of coins on the dispensing tray 7 is determined (S4).

The time set for the judgment of S4 is an allowable time during which the existence of coins on the dispensing tray 7 is forbidden. The allowable time, during which coins may be picked up by the user from the dispensing tray 7 but then drop from the hand of the user, is stored in a nonvolatile memory that can be rewritable, for example, such as a ROM 21. Specifically, the allowable time can be set to be 0.8 second or so for the operation of a cashier or be assumed to be about 0.1-2.0 second.

For a period that the allowable time does not elapse from the time that no residual coins on the dispensing tray 7 is detected in S4 (S4: No), the CPU 20 serving as a residual coin detector returns to the processing of S3 to maintain the setting the existence of residual coins and thus the detection is made as if the residual coins exist by repeating the processing of S3 and S4. That is, with the coin processing apparatus 1, a correct detection can be made even if the user drops coins on the dispensing tray 7 after coins are dispensed and picked up from the dispensing tray 7. Consequentially, if there is a possible period that dropping coins may occur, the flow will not advance to the next procedure (e.g. the next receiving/dispensing procedure) as no residual coins on the dispensing tray. As a result, if coins are dropped on the dispensing tray 7 during the possible period (allowable time), the dropped coins are also reported as residual coins.

Besides, the CPU 20 sets the state flag indicating presence/absence of residual coins as ‘no residual coins’ (S5) if the allowable time elapses from the time that no coins on the dispensing tray 7 is determined (S4: Yes). Thus, the CPU 20 detects that no residual coins exist on the dispensing tray 7 if the state that no coins exist on the dispensing tray 7 passes over the allowable time. Then, the CPU 20 determines there are no residual coins and proceeds to the next coin insertion/takeout operation to enable the user to insert or take out coins (S6). As stated above, the coin processing apparatus 1 prevents a transfer to the next processing (e.g. the next receiving procedure) when there are coins dropped.

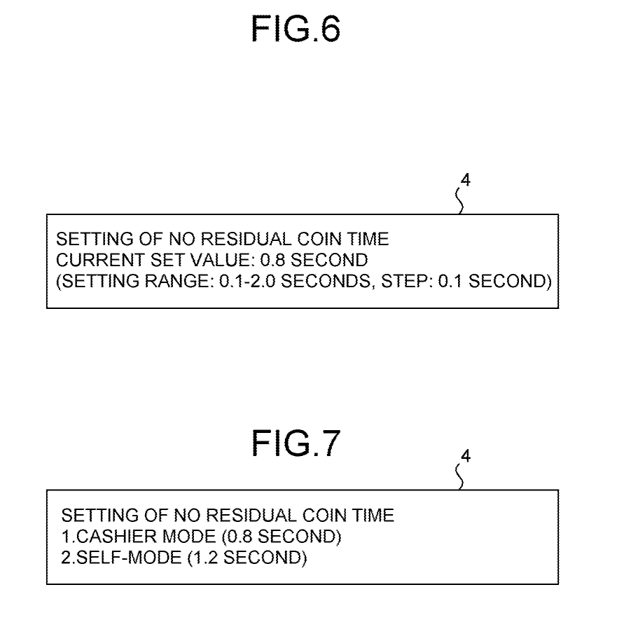

In addition, as to the allowable time described above, the setting screen of the allowable time may be displayed on the display 4 and the user may properly set an allowable time such that the setting operation of a desired allowable time by the user is accepted through the operation panel 5 and the desired allowable time is stored in the nonvolatile memory such as the ROM 21. FIG. 6 and FIG. 7 are diagrams showing exemplary display contents of the display, more specifically, FIG. 6 and FIG. 7 exemplarily show setting screen images of an allowable time.

As shown in FIG. 6, the allowable time as the current set value can be set by changing at 0.1 second intervals in the range of 0.1-2.0 second by operating the operation panel 5. Thus, the allowable time can be fined by, for example, 0.1 second at a step. The setting of a shorter allowable time shortens the wait time for the transfer to the next processing. Thus, a redundant wait time can be eliminated by fining the allowable time to be approximate to a period that dropping coins may occur.

In addition, as shown in FIG. 7, for the allowable time, a casher-mode that a cashier (shop clerk) carries out operations or a self-mode that a customer carries out operations can be set by operating the operation panel 5, and the values corresponding to a selected mode can be set as an allowable time. Occurrences of dropping coins from the hands of skilled cashiers and customers are different in probabilities and periods that dropping coins occur are also different. Specifically, coins are less likely to drop from the hand of a cashier, and a period that dropping coins occur is also shorter compared with a customer. Thus, based on a selected user mode (cashier-mode or self-mode), a proper allowable time can be easily set.

Besides, the program executed in the coin processing apparatus 1 provided in this embodiment is programmed in and provided by the ROM, or stored in and provided by computer-readable storage mediums such as CD-ROM, floppy disk (FD), CD-R and digital versatile disk (DVD) in an installable or executable manner.

Moreover, the program executed in the coin processing apparatus 1 provided in this embodiment may also be stored in a computer connected with a network such as the Internet and loaded from the network to be used, or provided or allocated by the Internet.

The program executed in the coin processing apparatus 1 provided in this embodiment consists of modules including a residual coin detector and a setter, and the actual hardware CPU reads a program from the ROM and executes the program to download the modules to a main memory and generate the modules on the main memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coin processing apparatus, comprising:
a dispensing tray configured to hold dispensed coins;
a detection sensor configured to detect presence/absence of the dispensed coins on the dispensing tray; and
a residual coin detector configured by which the existence of the residual coins on the dispensing tray is detected if the time during no dispensed coins on the dispensing tray is beyond an allowable no-coin time.

2. The apparatus according to claim 1, wherein
the residual coin detector configured to detect no residual coins after that the elapsed time from the time when coins are dispensed until the time of no coins on the dispensing tray is passed the allowable time.

3. The apparatus according to claim 1, further comprising:
an operating device configured to accept the operation of the allowable time; and
a setter configured to set the allowable time based on the accepted operation.

4. The apparatus according to claim 2, further comprising:
an operating device configured to accept the operation of the allowable time; and
a setter configured to set the allowable time based on the accepted operation.

5. A coin processing method, comprising:
detecting whether or not there are dispensed coins on a dispensing tray; and
detecting residual coins on the dispensing tray at the time that the elapsed time from when coins are dispensed until when there is not any coins on the dispensing tray is not passed an allowable time.

6. The method according to claim 5, wherein
the detecting of residual coins detects no residual coins after that the elapsed time from the time when coins are dispensed until the time of no coins on the dispensing tray is passed the allowable time.
